(19) United States
(12) Patent Application Publication
(10) Pub. No.: US 2019/0133026 A1
(43) Pub. Date: May 9, 2019

(54) Modular Farm Control and Monitoring System

(71) Applicant: Freight Farms, Inc., Boston, MA (US)

(72) Inventors: Kyle SEAMAN, Bedford, MA (US); Brad McNAMARA, Boston, MA (US); Jon FRIEDMAN, Boston, MA (US)

(21) Appl. No.: 16/091,348

(22) PCT Filed: Apr. 4, 2017
(86) PCT No.: PCT/US17/25916

§ 371 Date: Oct. 4, 2018

Related U.S. Application Data
(60) Provisional application No. 62/317,895, filed on Apr. 4, 2016.

(51) Int. Cl. A01B 79/00; G05B 19/042; A01G 22/00

(52) U.S. Cl. CPC A01B 79/005; G05B 19/042; H04L 67/12; G05B 2219/2625; G05B 2219/2614; A01G 22/00

(57) ABSTRACT

A system and method for monitoring and controlling a modular farm are provided. The system includes a farm networking service that provides monitoring and control of farm operations for farms that are part of the network. The farm networking service can transmit controlling instructions and notifications to the farms in the network. Users can upload data associated with a farm and farm operations to the farm networking service. The farm networking service can learn from aggregated data to enable best practices, crop recipes, and other information for all of the farms in the network.

### CROSS REFERENCE TO RELATED APPLICATIONS

This application claims priority under 35 § 119(e) of U.S. Provisional Application No. 62/317,895 filed on Apr. 4, 2016, entitled “Modular Farm Control and Monitoring System,” the disclosure of which is hereby incorporated by reference.

### BACKGROUND

The need for fresh food is growing as the population increases and changes in the climate impact growing seasons. The current food supply model, based on traditional farming methods and long distance shipping, is economically and environmentally unsustainable. Traditional farming operations are usually located in agricultural areas, which require large upfront costs and large acreage and have high operational costs from seed to sale.

Urban and local agriculture also faces obstacles. Growing space in urban areas is limited and not sufficient to meet a high demand. High start-up and operating costs of greenhouses make local crop production difficult for many businesses. Structures intended to support rooftop greenhouses must be evaluated by structural engineers and often require additional bracing to support the weight. Urban gardens often must address contaminated soil. Hydroponics systems are not easily used in urban locales, as most hydroponic systems are meant to be installed in agricultural settings, are not easily transportable, and require extensive training of personnel for operation.

Contained agricultural systems have recently been developed to address these issues. For example, a growing system in a modular container, described in U.S. Pat. No. 9,288,948, has been developed for generating high-yield crops. Within the modular container, the growing system includes a germination station for nurturing seeds until they germinate into plants, a plurality of vertical racks to hold the growing plants, a lighting system to provide appropriate light for the plants, an irrigation system to provide nutrients to the plants, a climate control system to control the environmental conditions within the container, and a ventilation system for providing airflow to the plants.

### SUMMARY OF THE INVENTION

A control and monitoring system and method for a network of modular farms is provided. Data generated by an individual farm can be aggregated with data from other farms. Farms can be controlled based on information learned from multiple farms in a network.

Other aspects and embodiments of the system and method include the following:

1. A system for controlling a network of farms comprising:

one or more processors and memory, and machine-readable instructions stored in the memory that, upon execution by the one or more processors cause the system to carry out operations comprising:

receiving communications from a plurality of remotely located modular farms, each modular farm comprising a contained environment for growing a crop, the communications including at least data from one or more of a sensor and equipment within the contained environment; and

transmitting a communication to at least one of the modular farms comprising instructions or notifications regarding growing conditions within the contained environment.

2. The system of embodiment 1, wherein the received communications further include one or more of data relating to crop yield, climate within the contained environment, farm equipment, and farm operations.
3. The system of embodiment 2, wherein the crop yield data includes an amount of a crop harvested over a time period.
4. The system of any of embodiments 2-3, wherein the climate data includes one or more of humidity, CO₂ level, temperature, light level, air flow across a crop, water levels supplied to a crop, nutrient levels supplied to a crop, and nutrient solution parameters, sensed over time within the contained environment.
5. The system of any of embodiments 2-4, wherein the farm equipment data includes one or more of a duty cycle, nutrient solution reservoir level, nutrient supply reservoir level, fuel tank level, equipment failure notification, and maintenance action notification sensed over time.
6. The system of any of embodiments 2-5, wherein the farm operations data includes amounts of resources consumed over a time period, the resources including one or more of fuel, electricity, water, and nutrients.
7. The system of any of embodiments 1-6, wherein the communications are received at [symbol] minute.
8. The system of any of embodiments 1-7, wherein the received communications include user generated data including one or more of pricing data, operational data, location data, purchases, and support data.
9. The system of any of embodiments 1-8, further comprising one or more modules operative to monitor and control components of each modular farm, the components including one or more of a sensor, equipment, crop recipe, farm organization, user authentication, rule, alert, data verification and settings.
10. The system of any of embodiments 1-9, further comprising aggregating data from multiple modular farms, the aggregated data including data relating to one or more of a crop yield, crop sale pricing, climate data, equipment data, and farm operations data.
11. The system of embodiment 10, further comprising determining from the aggregated data, one or more of crop recipe optimization for a particular crop, an equipment maintenance prediction, and a predicted yield for a particular crop.
12. The system of any of embodiments 10-11, further comprising determining from the aggregated data, one or more of local or regional crop yields, crop pricing, and crop demand.
13. The system of any of embodiments 1-12, wherein the transmitted communication includes instructions to carry out operations comprising controlling and monitoring one or more of a lighting system, an irrigation system, a climate control system, and a ventilation system within the contained environment.
14. The system of any of embodiments 1-13, wherein the transmitted communication includes a notification to users associated with each of the modular farms.
15. The system of embodiment 14, wherein the notifications are pushed to user devices that are subscribed to receive the notifications.
16. A method for controlling a network of farms comprising:

receiving, at one or more processors, communications from a plurality of remotely located modular farms, each modular farm comprising a contained environment for growing a crop, the communications including at least data from one or more of a sensor and equipment within the contained environment; and

transmitting, by the one or more processors, a communication to at least one of the modular farms comprising instructions or notifications regarding growing conditions within the contained environment.

17. The method of embodiment 16, wherein the received communications further include one or more of data relating to crop yield, climate within the contained environment, farm [symbol] operations.
18. The method of embodiment 17, wherein the crop yield data includes an amount of a crop harvested over a time period.
19. The method of any of embodiments 17-18, wherein the climate data includes one or more of humidity, CO₂ level, temperature, light level, air flow across a crop, water levels supplied to a crop, nutrient levels supplied to a crop, and nutrient solution parameters, sensed over time within the contained environment.
20. The method of any of embodiments 17-19, wherein the farm equipment data includes one or more of a duty cycle, nutrient solution reservoir level, nutrient supply reservoir level, fuel tank level, equipment failure notification, and maintenance action notification sensed over time.
21. The method of any of embodiments 17-20, wherein the farm operations data includes amounts of resources consumed over a time period, the resources including one or more of fuel, electricity, water, and nutrients.
22. The method of any of embodiments 16-21, wherein the communications are received at intervals of about 1 minute.
23. The method of any of embodiments 16-22, wherein the received communications include user generated data including one or more of pricing data, operational data, location data, purchases, and support data.
24. The method of any of embodiments 16-23, further comprising aggregating data from multiple modular farms, the aggregated data including data relating to one or more of a crop yield, crop sale pricing, climate data, equipment data, and farm operations data.
25. The method of embodiment 24, further comprising determining from the aggregated data, one or more of crop recipe optimization for a particular crop, an equipment maintenance prediction, and a predicted yield for a particular crop.
26. The method of any of embodiments 24-25, further comprising determining from the aggregated data, one or more of local or regional crop yields, crop pricing, and crop demand.
27. The method of any of embodiments 16-26, wherein the transmitted communication includes instructions to carry out operations comprising controlling or monitoring or both controlling and monitoring one or more of a lighting system, an irrigation system, a climate control system, and a ventilation system within the contained environment.
28. The method of any of embodiments 16-27, wherein the transmitted communication includes a notification to users associated with each of the modular farms.
29. The method of embodiment 28, wherein the notifications are pushed to user devices [symbol] receive the notifications.
30. A system for monitoring and controlling a farm over a network, comprising:

one or more processors and memory, and machine-readable instructions stored in the memory that, upon execution by the one or more processors cause the system to carry out operations comprising:

transmitting communications from at least one modular farm to a remote computing system, the modular farm comprising a contained environment for growing a crop, the communications including at least data from one or more of a sensor and equipment within the contained environment; and

receiving a communication from the remote computing system comprising instructions or notifications regarding growing conditions within the contained environment.

31. The system of embodiment 30, wherein the transmitted data includes data relating to one or more of a crop yield, climate within the contained environment, farm equipment, and farm operations.
32. The system of any of embodiments 30-31, wherein the transmitted data includes user generated data comprising one or more of pricing data, operational data, location data, purchases, and support data.
33. The system of any of embodiments 30-32, further comprising, at the modular farm, a communication gateway device to enable communication between the modular farm and the remote computing system, and with one or more user devices associated with the modular farm.
34. The system of embodiment 33, wherein the user device is a personal computer, laptop computer, tablet computer, mobile device, smart phone, smart watch, or wearable device.
35. The system of any of embodiments 33-34, wherein the communication gateway device is operative to transmit and receive communications over a wired network or a wireless network.
36. The system of any of embodiments 30-35, wherein the contained environment of the modular farm comprises a container housing racks for growing plants, a lighting system configured to provide light for the plants, an irrigation system configured to provide nutrients to the plants, a climate control system configured to control environmental condition within the container, and a ventilation system configured to provide airflow to the plants.
37. The system of embodiment 36, further comprising machine-readable instructions stored in the memory that, upon execution by the one or more processors, cause the system to carry out operations comprising controlling and monitoring one or more of the lighting [symbol] system, the climate control system, and the ventilation system.
38. A method for monitoring and controlling a farm over a network, comprising:

transmitting, by one or more processors, communications from at least one modular farm to a remote computing system, the modular farm comprising a contained environment for growing a crop, the communications including at least data from one or more of a sensor and equipment within the contained environment; and

receiving, by the one or more processors, a communication from the remote computing system comprising instructions or notifications regarding growing conditions within the contained environment.

39. The method of embodiment 38, wherein the transmitted data includes data relating to one or more of a crop yield, climate within the contained environment, farm equipment, and farm operations.
40. The method of any of embodiments 38-39, wherein the transmitted data includes user generated data comprising one or more of pricing data, operational data, location data, purchases, and support data.
41. The method of any of embodiments 38-40, further comprising, at the modular farm, a communication gateway device to enable communication between the modular farm and the remote computing system, and with one or more user devices associated with the modular farm.
42. The method of embodiment 41, wherein the user device is a personal computer, laptop computer, tablet computer, mobile device, smart phone, smart watch, or wearable device.
43. The method of any of embodiments 41-42, wherein the communication gateway device is operative to transmit and receive communications over a wired network or a wireless network.
44. The method of any of embodiments 38-43, wherein the contained environment of the modular farm comprises a container housing racks for growing plants, a lighting system configured to provide light for the plants, an irrigation system configured to provide nutrients to the plants, a climate control system configured to control environmental condition within the container, and a ventilation system configured to provide airflow to the plants.
45. The method of embodiment 44, further comprising monitoring one or more of the lighting system, the irrigation system, the climate control system, and the ventilation system.
46. The method of any of embodiments 44-45, further comprising controlling one or more of the lighting system, the irrigation system, the climate control system, and the ventilation [symbol]
47. A system of controlling a farm, comprising:

one or more processors and memory, associated with a farm comprising a contained environment for growing a crop, and machine-readable instructions stored in the memory that, upon execution by the one or more processors cause the system to carry out operations for controlling and monitoring farm operations, and

a user device in communication with the one or more processors,

wherein the operations comprise displaying on the user device a plurality of farm control operations comprising one or more of lighting control, ventilation control, growing chamber parameters, and seedling chamber parameters.

48. The system of embodiment 47, further comprising displaying on the user device a camera feed from an interior of a modular container.
49. The system of any of embodiments 47-48, further comprising providing one or more of a historical log, a run log, and alert notifications.
50. The system of any of embodiments 47-49, wherein the growing chamber parameters or the seedling chamber parameters include one or more of air temperature, humidity, CO₂ level, nutrient tank temperature, nutrient tank pH level, and nutrient tank electrolyte conductivity.
51. A method of controlling a farm, comprising:

transmitting to a user device associated with a farm a display comprising a plurality of farm control operations comprising one or more of lighting control, ventilation control, growing chamber parameters, and seedling chamber parameters.

52. The system of any of embodiments 1-15, wherein the transmitted communication includes instructions for executing farm operation tasks.

### DESCRIPTION OF THE DRAWINGS

The invention will be more fully understood from the following detailed description taken in conjunction with the accompanying drawings in which:

FIG. 1 is a schematic diagram of an embodiment of a system architecture for the control and monitoring of a network of modular farms;

FIG. 2 is a schematic diagram of an embodiment of one farm in communication with a farm networking service;

FIG. 3 is a schematic diagram of an embodiment of a farm control system;

FIG. 4 is a schematic diagram of an embodiment of a contained environment of a

[symbol]

FIG. 5 is a schematic diagram of an embodiment of a farm networking service;

FIG. 6 is a schematic flow chart of an embodiment of a farm operation monitoring process;

FIG. 7 is a schematic block diagram of embodiments of modules used in a farm networking service;

FIG. 8 is an embodiment of a data structure for settings;

FIG. 9 is an embodiment of a data structure for equipment;

FIG. 10 is a schematic diagram of an embodiment of a publish-subscribe architecture used in a farm networking service;

FIG. 11 is a further schematic diagram of an embodiment of a publish-subscribe architecture used in a farm networking service;

FIG. 12 is a schematic diagram of a further communication architecture used in a farm networking service;

FIG. 13 is a schematic illustration of a machine learning algorithm;

FIG. 14 is an illustration of a user interface for tracking farm operations on a mobile device;

FIG. 15 is an illustration of an embodiment of a user interface for monitoring farm operations on a user device;

FIG. 16 is an illustration of an embodiment of user interfaces for monitoring farm operations on a user mobile device;

FIG. 17 is an illustration of an embodiment of a user interface for controlling farm operations on a user device;

FIG. 18 is an illustration of an embodiment of user interfaces for controlling farm operations on a user mobile device;

FIG. 19 is an illustration of an embodiment of a user interface for monitoring alerts regarding farm operations on a user device;

FIG. 20 is an illustration of an embodiment of user interface for monitoring alerts regarding farm operations on a user mobile device;

FIG. 21 is an illustration of an embodiment of a user interface for viewing historical data regarding farm operations on a user device;

FIG. 22 is an illustration of an embodiment of user interfaces for viewing historical data regarding farm operations on a user mobile device;

FIG. 23 is an illustration of an embodiment of a user interface for tracking and [symbol] on a user device;

FIG. 24 is an illustration of an embodiment of a user interface for tracking and performing user operations on a user mobile device; and

FIG. 25 is an embodiment of a data structure for parameters.

### DETAILED DESCRIPTION OF THE INVENTION

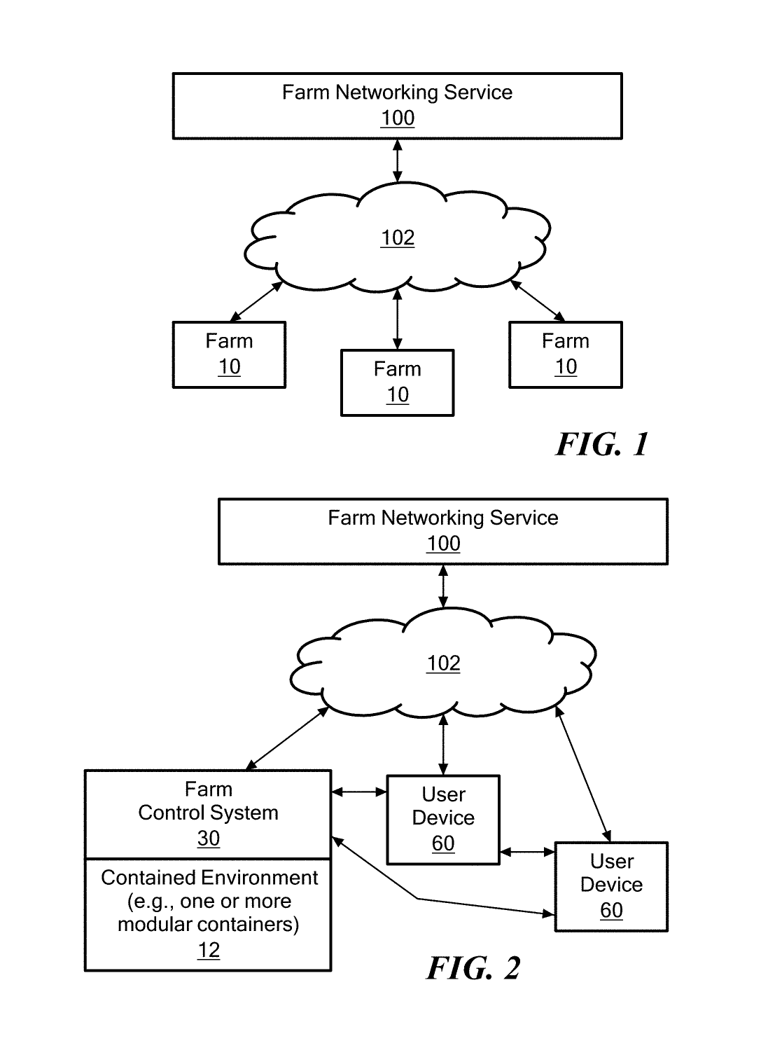

FIG. 1 is a schematic illustration of a farm network including an embodiment of a farm networking service 100 in communication, via a communication network 102, with a number of modular farms 10. The farm networking service can provide monitoring and control of farm operations for each of the farms that are part of the network. The farm networking service can monitor various parameters and, based on the obtained data, can provide automatic control of farm operations and/or can provide notifications to one or more users associated with each farm. User control of farm operations can be enabled remotely from a user device. A user can upload data associated with a farm and farm operations to the farm networking service. The farm networking service can learn from the monitored and uploaded data to adjust parameters of farm operations. The farm networking service can aggregate data from multiple farms in the network to enable learning of best practices, crop recipes, and other information for all of the farms in the network. The farm networking service can enable an automated farm marketplace for the buying and selling of crops based on aggregated data.

FIG. 2 is a schematic illustration of a single modular farm 10 in communication with the farm networking service 100 via a communication network 102 such as the Internet. In some embodiments, the modular farm includes one or more modular containers that form a contained environment 12 for a growing system in which one or more crops can be grown under controlled conditions to achieve high crop yields. A farm control system 30 is provided to monitor and control the various components of the growing system within the contained environment, described further below. The farm control system can be located within the contained environment 12, such as within one or more of the modular containers, or can be located outside of the contained environment, such as within a control room attached to or near to the contained environment. The farm control system can be distributed across multiple containers that together form the contained environment of a farm. One or more user devices 60 in communication with the farm control system can be provided to enable a user, for example, a farmer, to monitor and control farm operations.

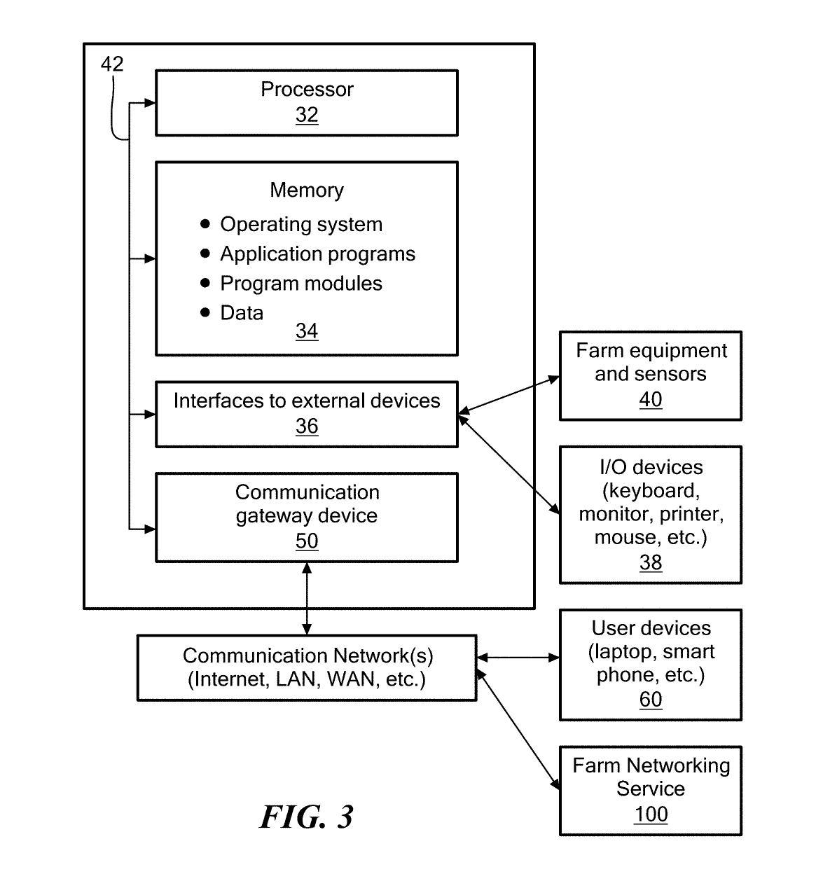

Referring to FIG. 3, in some embodiments, the farm control system can include one or more processors 32 for carrying out operations, such as application program instructions, and [symbol] of application programs and program modules, data, and other typical items, such as a BIOS. The farm control system can include interfaces 36 to input/output devices 38, such as a keyboard, monitor, printer, mouse, and the like, and to external devices, such as the farm equipment and sensors 40, described further below. A system or other bus 42 can be provided to enable communication between elements within the farm control system.

The farm control system includes a communication gateway device 50 to enable communication with the one or more user devices 60 associated with the farm 10. The user devices 60 can be located remotely from the farm control system 30 and/or the contained environment 12. Such user devices can include, without limitation, a personal computer, laptop computer, tablet computer, mobile device, smart phone, smart watch, wearable device, and the like. The communication gateway device 50 can also enable communication with the farm networking service 100. The communication gateway device can provide communication over any suitable network or combination of networks, such as, without limitation, an intranet, a local area network, a wide area network, or the Internet. Communication can be wired or wireless or a combination thereof. The user devices can also be enabled to communicate with other user devices associated with the farm and with the farm networking service, described further below.

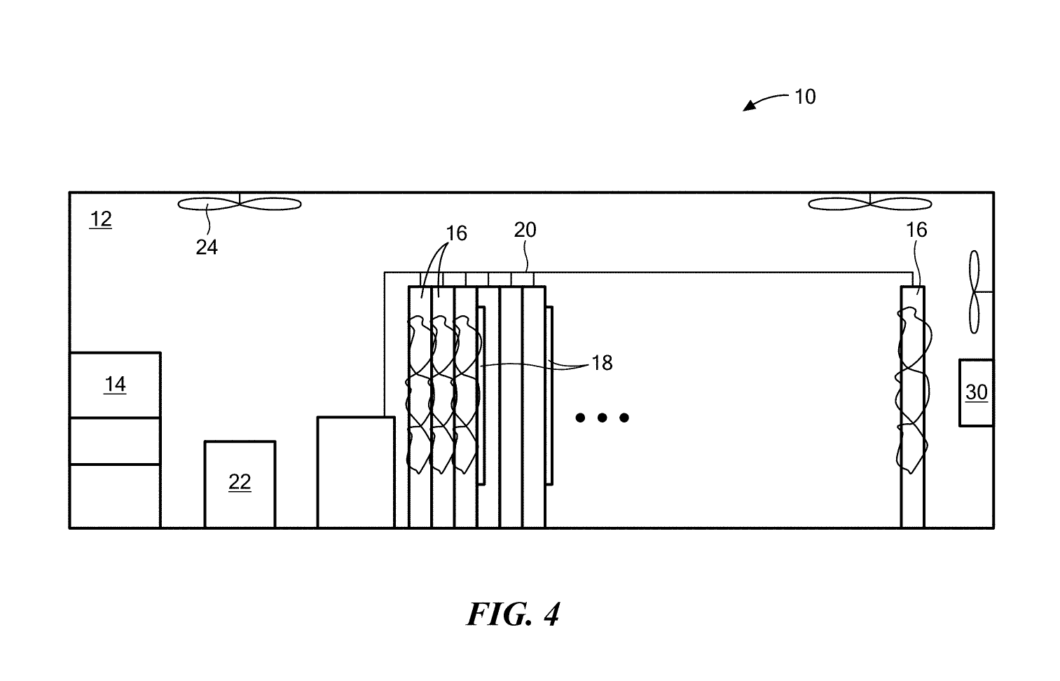

One example of a modular farm 10 is illustrated schematically in FIG. 4. Within a container 12, a growing system can include elements such as a germination station 14 for nurturing seeds until they germinate into plants, a plurality of vertical racks 16 to hold the growing plants in the contained environment, a lighting system 18 to provide appropriate light for the plants, an irrigation system 20 to provide nutrients to the plants, a climate control system 22 to control the environmental conditions within the contained environment, and a ventilation system 24 for providing airflow to the plants. The farm control system 30 is provided within the container for monitoring and controlling the components of the growing system. One exemplary growing system in a modular container is described in U.S. Pat. No. 9,288,948, incorporated by reference herein.

At each modular farm, the farm control system controls and monitors various components of the growing system. The components can include equipment such as a nutrient solution reservoir, pumps, valves, tubing, aerators, and water filters to provide irrigation; a nutrient doser to introduce various nutrients, such as phosphates, nitrates, and trace minerals from nutrient supply reservoirs, into water in the nutrient solution reservoir; fans, vents, and air filters for ventilation; lights, such as LED lights; motors for moving lights [symbol] VAC equipment for heating and cooling; still and video cameras for providing visual monitoring of the plants within the contained environment; and electrical generators, batteries, solar panels, fuel tanks, and the like for power. Components can also include various sensors to monitor conditions inside the contained environment, such as temperature sensors, humidity sensors, and CO₂ sensors, and sensors to detect the pH, acidity, conductivity, oxygen content, and temperature of the nutrient solution.

The farm control system 30 can monitor and control the components based on specifications set by a user or on preset specifications for a particular crop. For example, the control system can monitor a climate control system and can change humidity, CO₂ level, temperature, and other parameters in order to remain within specified values. The control system can be coupled to switches of a lighting system to control the lighting based on factors such as time of day and an on/off duty cycle. The control system can be coupled to sensors and valving of an irrigation system to ensure that the proper nutrient concentration for a specific crop is being maintained in the nutrient reservoir. For example, the type and amount of nutrients added into a nutrient reservoir to maintain specific nutrient levels can be controlled, depending on the type of plant being grown. The pH and acidity level of the nutrient solution can be controlled. The control system can monitor and control the amount of nutrient solution being dripped onto specific grow channels or specific sections of grow channels. The control system can be coupled to motors and switches of a ventilation system to ensure the proper airflow is being maintained for various sections of plants. The control system can be in communication with one or more cameras to capture visual records of plant growth. The above are illustrative examples of components that can be monitored and controlled in order to ensure maintenance of optimal growing conditions; other components can be monitored and controlled, as will be understood by those of skill in the art.

The values for the variable parameters can be selected based on the crop desired and the optimal environmental and feeding conditions for that crop. The user can set and modify levels, modify and/or override any pre-set levels, or merely monitor activity in the contained environment. The farm control system can be configured to issue alerts of equipment failures, maintenance schedules, changes in conditions, or other variations from the prescribed levels. The user can perform any or all of these actions from a user device in communication with the farm control system and/or via input/output devices in direct communication with the farm control system.

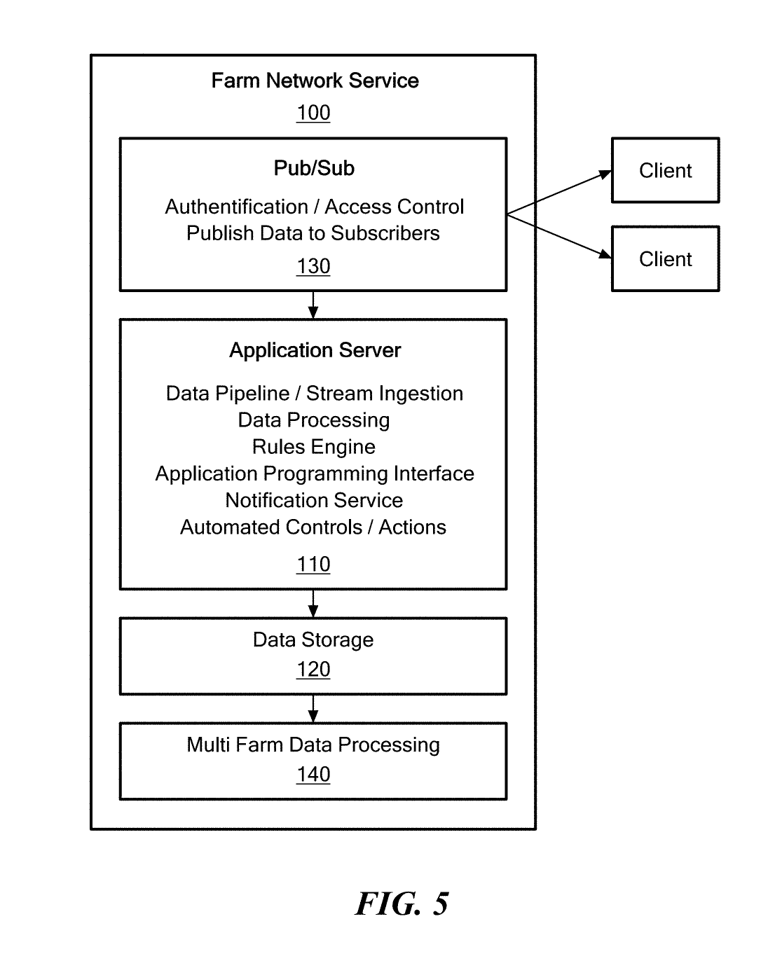

Referring to FIG. 5, in some embodiments, a farm networking service 100 can include an application server 110 and data storage 120. At the application server, one or more [symbol] and one or more application programming interface modules can be provided. The farm networking service can include a publication subscription module 130, for example, to manage access control, authenticate a connection request from a farm that is a member of the network or to authorize a user of a member farm seeking to connect to the service, and to publish data to subscribers. The farm networking service can include a multi-farm data processing module 140 to manage data from all of the farms belonging to the network. It will be appreciated that the farm networking service can include other servers, programs modules, and the like.

The farm networking service can be in communication with each farm control system located at the farms that are part of the network. The farm networking service can obtain data directly from the farm control system, including data such as, without limitation, climate data, equipment and operational data, and crop yield data. Climate data can include, without limitation, parameters within the contained environment such as humidity, CO₂ levels, temperature, light levels, air flow across the crops, water and nutrient levels supplied to the crops, and parameters of the nutrient solution such as pH, conductivity, oxygen content, and temperature. Equipment data can include, without limitation, duty cycles, nutrient solution reservoir level, nutrient supply reservoir levels, fuel tank levels, and equipment failures and maintenance actions. Operational data can include, without limitation, amounts of resources consumed over a time period, such as the volume of water and fuel or pounds of nutrients. Yield data can include, without limitation, the amount of a particular crop harvested over a time period. The amount can be measured in any suitable units, such as pounds, number of heads, and the like. For example, farm yield data can include, for example, the number of heads of lettuce produced annually or the number of pounds of basil produced annually. The time period can be any suitable time period, such as days, weeks, months, or annually.

In some embodiments, the farm networking service can obtain the data from a farm control system on a periodic schedule, such as, without limitation, at 1-minute intervals, 5-minute intervals, 10-minute intervals, 30-minute intervals, 1-hour intervals, 6-hour intervals, 12-hour intervals, or 24-hour intervals. Data can be obtained at other time intervals if desired. Different types of data can be obtained at different time intervals. The data is stored in the data storage, which is preferably optimized for time series data, since many of the parameters vary over time.

In some embodiments, a user can upload to the farm networking service data that is obtained by the user or generated at the user's farm. Such data can include, without limitation, pricing data, operations data, location data, purchases, and support. Pricing data [symbol] the user obtained for the sale of a particular crop on a particular date in a particular local or regional market. Operations data can include data related to the climate, equipment, and crop yield at a farm. Location data can include a particular farm location, for example, if a farm includes containers located at multiple locations. Purchases can include any items purchased by the user from an on-line store or other store, the amounts, and the price paid. Purchased items can include, without limitation, seeds, growth media, nutrients, lights, equipment, and equipment parts for repair. Support can include any support services obtained by the user, such as consultation with a farm expert or a repair service for a piece of equipment.

In some embodiments, the farm networking service can include one or more applications that analyze the data received from an individual farm and send communications to the farm based on the analyzed data. Communications can include notifications sent to users at the user devices. Communications can include control instructions sent to the farm control system to carry out adjustment of parameters.

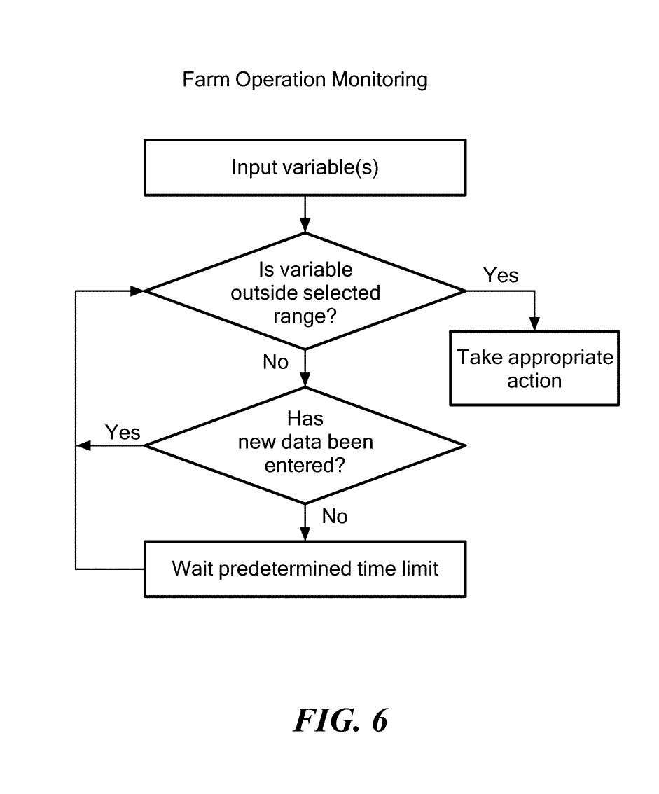

In some embodiments, the farm networking service can be operative to monitor various farm operations using selected filters. More particularly, for a particular operation, a module can be provided to monitor one or more variables and compare the variables to preset values. The module can determine if a variable exceeds a preset maximum, falls below a preset minimum, or otherwise falls outside a preset range, thereby triggering an action. Actions can include a notification sent to a user, or the transmission of a control signal to a piece of equipment at the farm. For example, a water pump can be monitored and turned off remotely if it runs longer than a determined time limit. A user notification can be a prediction of a cause or a likely outcome from a given input, following which a user can directly check the farm operation at issue. For example, a CO₂ level that has not risen while a generator has been continually running may be an indication that a propane tank is empty. A notification can be sent to the user to check the tank; upon checking the tank, a user can determine if the tank is actually empty and can replace or refill the tank. The modules can be programmed to run whenever new data is saved to the farm service or on a determined schedule. FIG. 6 illustrates an exemplary flow chart of a monitoring operation.

As another example, to maintain conditions or provide alerts, an application module can include algorithms relating to environmental conditions prescribed by the user. In one embodiment, an application module can utilize a series of if-then relationships to maintain optimal conditions. For example, if the humidity within the contained environment falls below a set limit, for example, 60%, then the farm networking service can send [symbol] alert the user and/or to the farm control system to activate a humidifier until the humidity level stabilizes at the desired level. In another example, if the temperature within the contained environment rises above a set limit, for example, 85° F., or falls below a set limit, for example, 66° F., then the farm networking service can send a communication to alert a user and/or to the farm control system to activate the climate control system until the temperature stabilizes at a desired temperature within the desired temperature range. The if-then relationships can be stored as program modules in the memory.

Data and processing modules can be packaged into one or more consumable application programming interfaces (APIs), enabling internal and external applications to be built with the farm data. The API provides a versatile interface between the operating system of the user's device and any of a variety of farm-related applications. Example APIs can include recipes, regional yields, pricing, farm production, farm data, farm operations, and maintenance.

In some embodiments, the API can conform to the constraints of representational state transfer (RESTful) architecture. Other API call formats or protocols can be used, such as, without limitation, HTML or XML tags, JavaScript, PHP, Python, Perl, or AJAX.

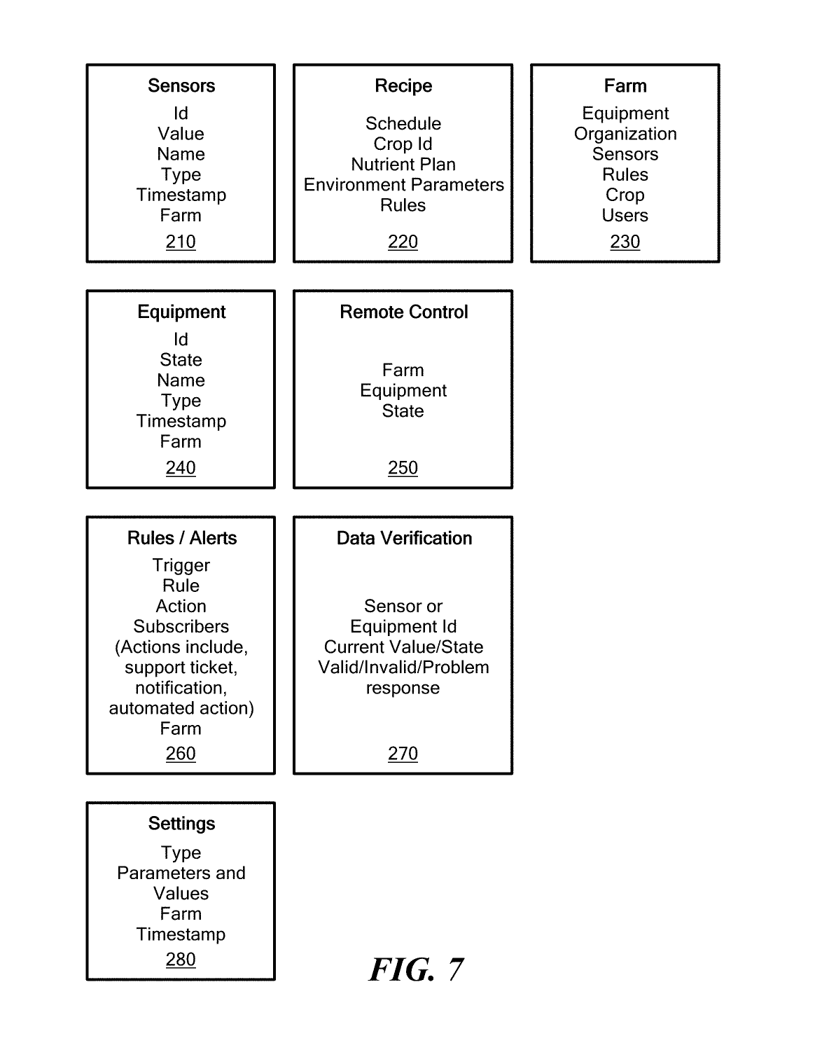

FIG. 7 schematically illustrates various example of modules for monitoring and controlling various components of the farm networking system. For example, a sensors modules 210 can include, for the sensors on each farm, an identification reference (“id”) of each sensor, data values, data types, timestamps, and farm identifications. A recipe module 220 can include, for each crop recipe, identification of the crop, a schedule, for example, transplant and harvest timelines, nutrient plans, environmental parameters, and rules, for example, to maintain equipment parameters and optimal climate. A farm module 230 can include, for each farm in the network, the equipment used on that farm, the organization of the farm (for example, where crops are located within the farm, which users have accessed the farm and for what time periods, any workflows performed on the farm), the sensors used on the farm, the rules used for the crops grown on the farm, and the users (the farmers who are authorized to access the farm networking system). An equipment module 240 can include, for the equipment on each farm, an identification reference for each piece of equipment, the state of the piece of equipment at a particular time (such as on or off), name, type, timestamp, and farm identification. A remote control operations module 250 can include, for each farm, an identification of each farm, the equipment to be monitored and controlled remotely on each farm, and the state of the equipment at any particular time. A rules/alerts module 260 can include parameters that trigger operation of a rule, a description of the rule, actions taken, [symbol] receive notifications, and farm identifications. Actions can include, for example, issuance of a support ticket, a notification, or an instruction to perform an automated action. A data verification module 270 can include sensor or equipment identification, current value and/or state of each sensor or piece of equipment, an indication of whether a data entry is valid or invalid, and a problem response. A settings module 280 can include the types of settings, parameters and values for each setting, an identification of each farm, and timestamps.

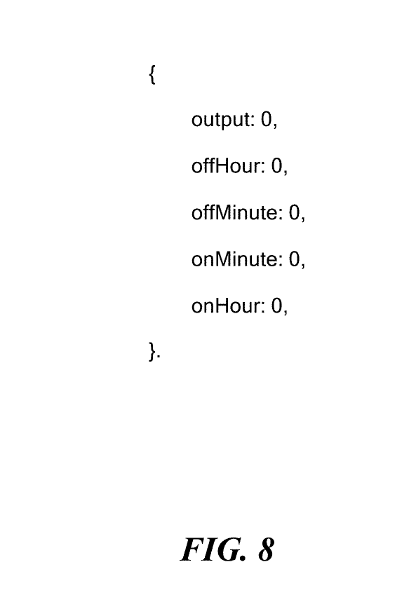

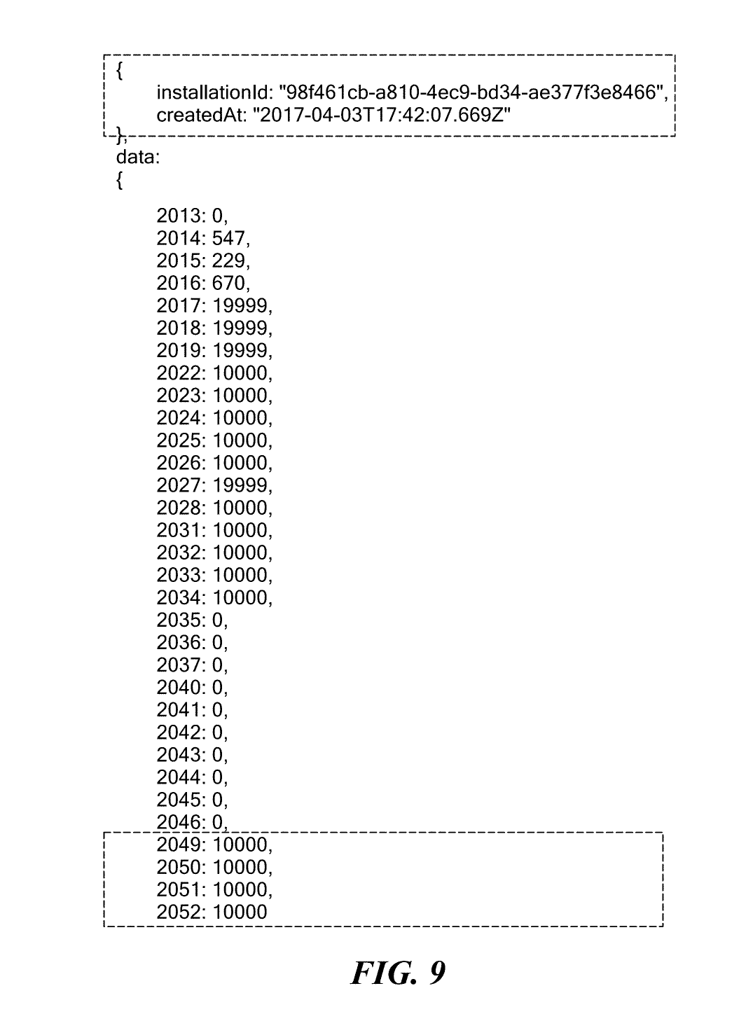

FIG. 8 is an illustration of an embodiment of a data structure that can be used for storing data relating to settings. The data can include an output and timestamps for off and on times. FIG. 9 is an illustration of an embodiment of a data structure that can be used for storing data relating to sensor values. The data can include values at various time intervals, such as every minute. FIG. 25 is an embodiment of a data structure for various parameters that can be used in an application programming interface.

Additional example applications can include applications to provide connections between the farm and remote devices and servers, a farm shop for purchasing items, a crop tracker, a return on investment (ROI) view, market and community supported agriculture (CSA) tools, fleet management, proactive support, and operation planners and schedulers.

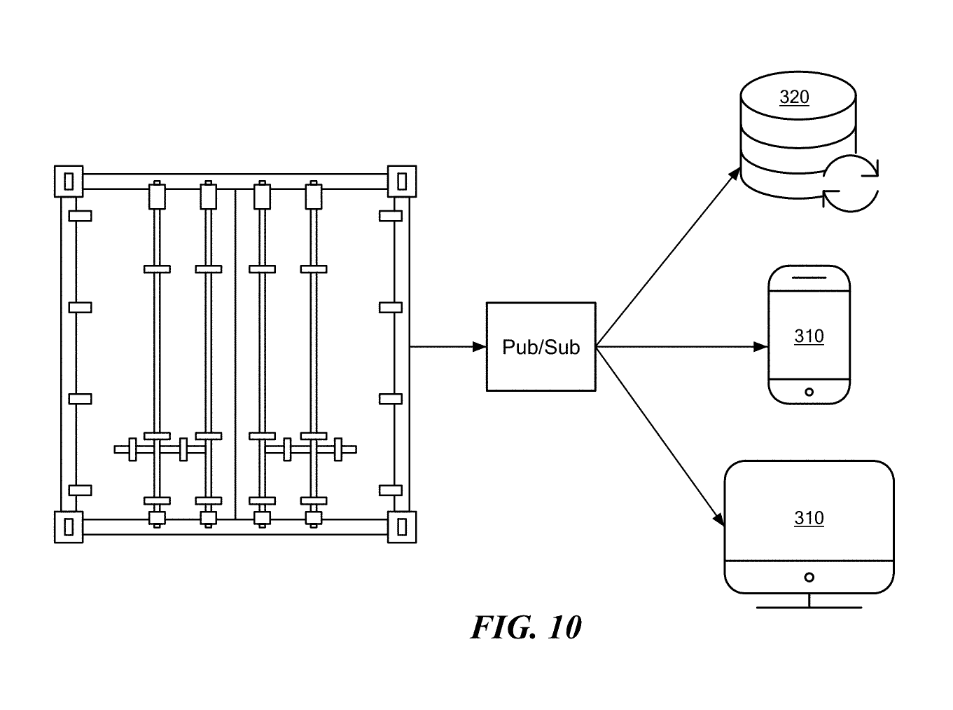

In some embodiments, communications can be sent automatically to a farm using a push messaging system. In some embodiments, communications can be sent using a publish-subscribe architecture in which communications are sent to those farms that have subscribed to receive certain topics or types of information. Referring to FIG. 10, communications can be sent to the various devices 310 of each subscribed user and to data storage devices 320, which can be updated upon receiving a communication. Users can select which notifications they wish to receive. For example, users who grow basil may select to receive notifications relating to basil, so that they can receive updates and notifications regarding the basil recipe, which can include information about, for example, the basil growth cycle and environment.

Auto control can enable a farm to take action on these notifications to optimize the environment for the basil based on the current growth period and any new information added to the recipe.

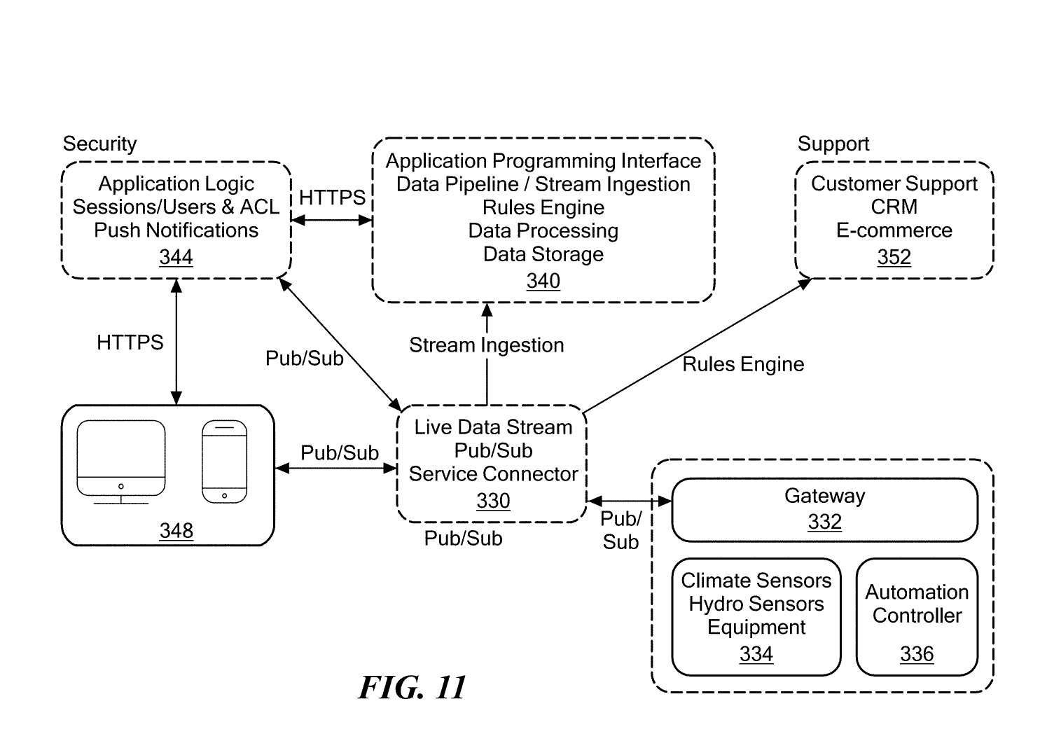

Referring to FIG. 11, in some embodiments, a farm networking service can include publish-subscribe architecture including a communication module or hub 330 to coordinate live data streams and function as a service connector as well as provide communications to farm network members. A farm networking service can provide a gateway 332, in communication with the hub, for transmitting communications regarding equipment and [symbol] without limitation, climate and hydro sensors, and an automation controller 336 for coordinating the automation of various tasks. The farm networking service can include an application programming interface 340 for coordinating a data pipeline or stream ingestion for data streaming, rules engine(s) used in data processing, and data storage. A farm networking service can include a security module 344 to handle application logic, track sessions and users, maintain an access control list (ACL), and coordinate push notifications to farms 348 over a secure channel or network, for example using the HTTPS protocol. A farm networking service can include a support module 352 for providing customer support, customer relations management applications, and e-commerce capabilities.

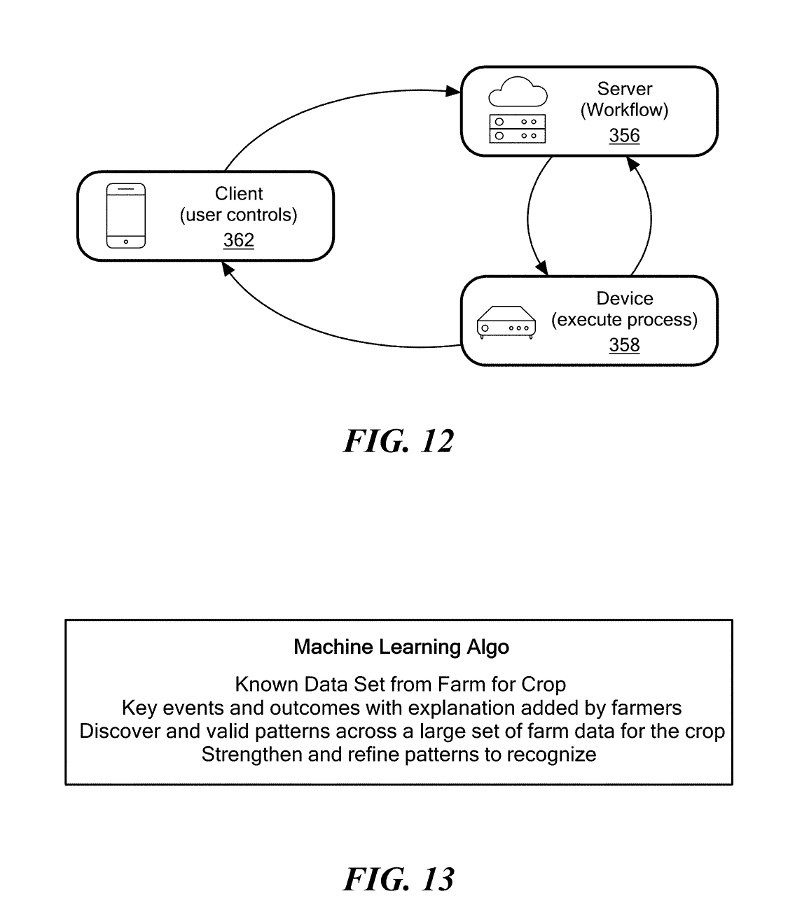

Referring to FIG. 12, in some embodiments, a farm networking service can utilize a three-party architecture for coordinating communications and execution of processes in situations in which a traditional request/response protocol does not provide sufficient capabilities. For example, in some situations, a process could take too long for an HTTP protocol and might time out. As a further example, a disconnect of a client device can occur for various reasons, which could be problematic during an important or time-critical process. In some embodiments, a farm networking service can include a server 356 or other processing device for coordinating workflows. Workflows can include any task or action needed to be performed at a farm, from simple tasks such as turning on lights, to more complex processes, such as calibrating sensors. The server can provide a capability for error handling and workflow logic, which shifts these capabilities off a client device 362. The server can be in communication with a further processing device 358 for executing the processes. This can enable continuous updates to the workflows and the addition of new workflows without the need for the client to provide the these functionalities or for client intervention.

At a network level, the farm network service can employ pattern processing using the aggregated data from multiple farms across the network. Pattern processing can include, for example and without limitation, patterns relevant to crops and operations, such as crop optimization, equipment optimization, maintenance predictions, workflow optimization, and predicted yields and the like. Pattern processing can include patterns relevant to local and/or regional market data, such as crop yields, pricing, and demand. For example, referring to FIG. 13, a machine learning algorithm can include a data set obtained from farms for a particular crop. Key events and outcomes can be added as available, automatically or by a user, with explanations, can be added by the farmers. The algorithm can discover and validate patterns across a large set of farm data for the crop and can strengthen and refine the patterns over [symbol] techniques can include supervised and unsupervised learning.

More particularly, the farm network service can employ one or more learning algorithms. For each farm in the network, the farm is continually monitored (on a periodic schedule, as noted above). At the network level, parameters can be analyzed and compared. Across an entire network, data relevant to the climate, equipment, and crop yield is collected and analyzed for current best growing parameters and settings. New information is saved.

Updates of existing recipes for a particular crop based on the new, learned information can be saved and updates sent to farms on the network.

Monitoring of various farm processes can be used to proactively predict and address issues and problems before they arise or before they lead to more serious disruption. The probability and types of issues can be determined as they evolve based on continuous data generated across the farm network. Similarly, maintenance schedules can be based on network learning from data generated across the farm network. For example, if data indicates a pattern in the timing of maintenance for a particular piece of equipment, a notification can be sent to users at farms with that equipment with a notification of the anticipated maintenance time. As another example based on learning across the network, user generated content and market data can provide farmers and farm operators with optimal crops to grow based on market demands

Regional crop supply predictions can be made based on the data gathered across the network. For example, using farm climate and equipment data for a particular crop, the final crop yield can be predicted based on a highest possible harvest. For example, data may show that the crop experienced a temperature swing of a certain amount. Based on learning from previous data, the predicted crop yield can be reduced due to this temperature swing. This data can be used to determine an amount of a specific crop that will enter the market in coming weeks. As a farm's output is tracked, a supply calendar can be generated to further predict the outcome of planned crops beyond the current harvest.

A recipe for a crop can include optimal climate, equipment parameters, and yield throughout a plant's growth lifecycle, as well as optimal transplant and harvest timelines. The farmer sets up the farm for growing a crop. Settings are transmitted to the farm networking service and saved. Using the farm network learning, the optimal conditions are determined. For example, from the aggregated data, a pattern may emerge that a particular crop has a higher yield at a particular temperature range, or if a particular amount of a certain nutrient is used. Recipes can be updated based on such recognized patterns. Any changes can be sent back to the farm.

An automated buy/sell marketplace can be offered based on supply predictions and user generated and market pricing data. For example, a buyer can place a bid on a particular crop, and a farmer can enter a sell price, recommended by the system. The buyer can accept the price, and can sell current and upcoming crops. This transaction can become part of the database of regional market pricing information.

A return on investment (ROI) of a farm can be predicted based on all the inputs (costs) and outputs (revenue) for the farm in real time.

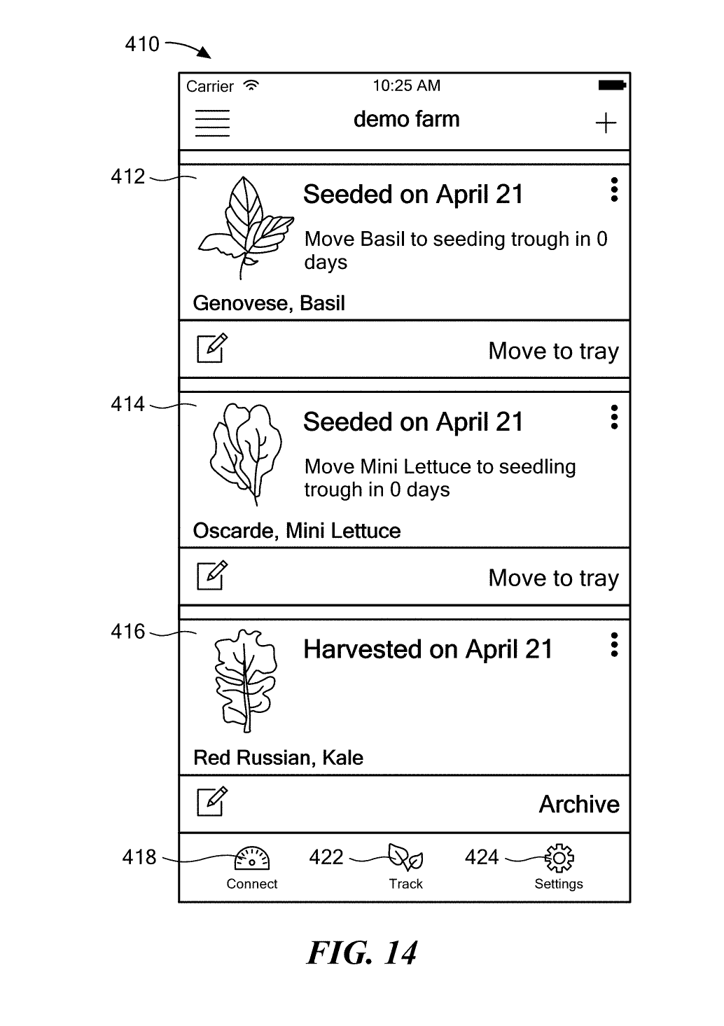

FIGS. 14-23 illustrate embodiments of user interface screens viewable on user devices, which can include, without limitation, a laptop or desktop computer or a mobile device such as a smartphone. User interfaces can be optimized for particular user devices, such as a laptop or a smartphone.

FIG. 14 illustrates an embodiment of a user interface for tracking crops 410, optimized for a mobile device. For example, the interface illustrates that basil 412 and lettuce 414 were moved to seedling troughs and kale 416 was harvested. The user can select various options by tapping an appropriate icon, such as connect 418 (to connect to a network), track 422 (to track one or more corps), or settings 424 (to view and change settings).

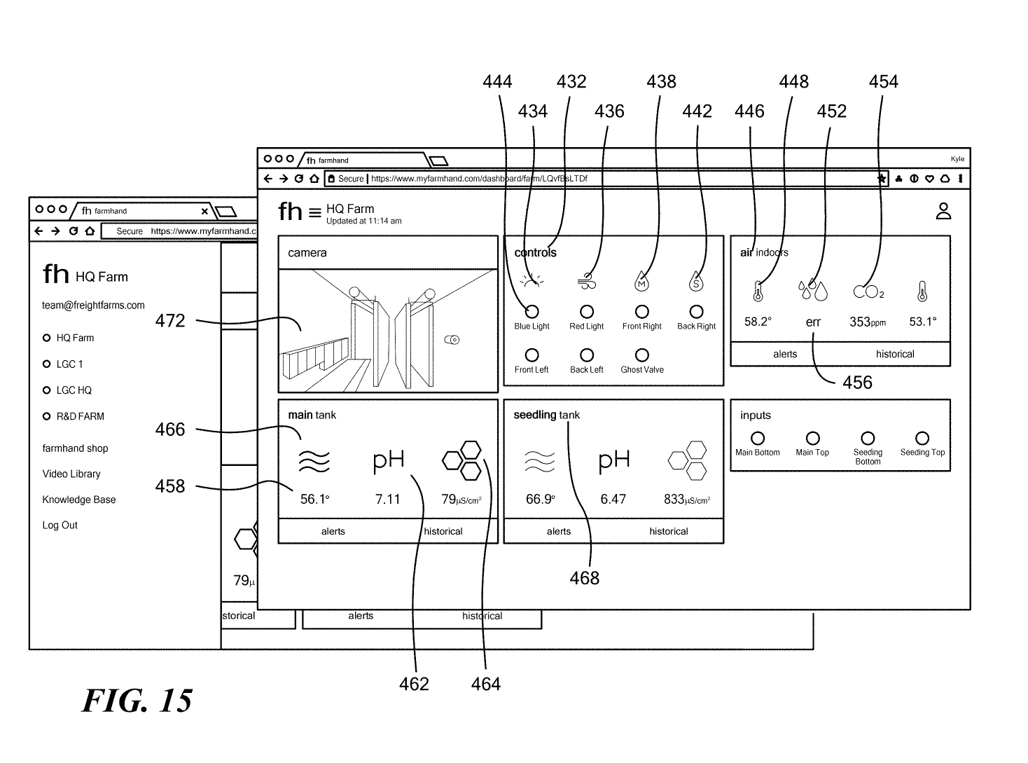

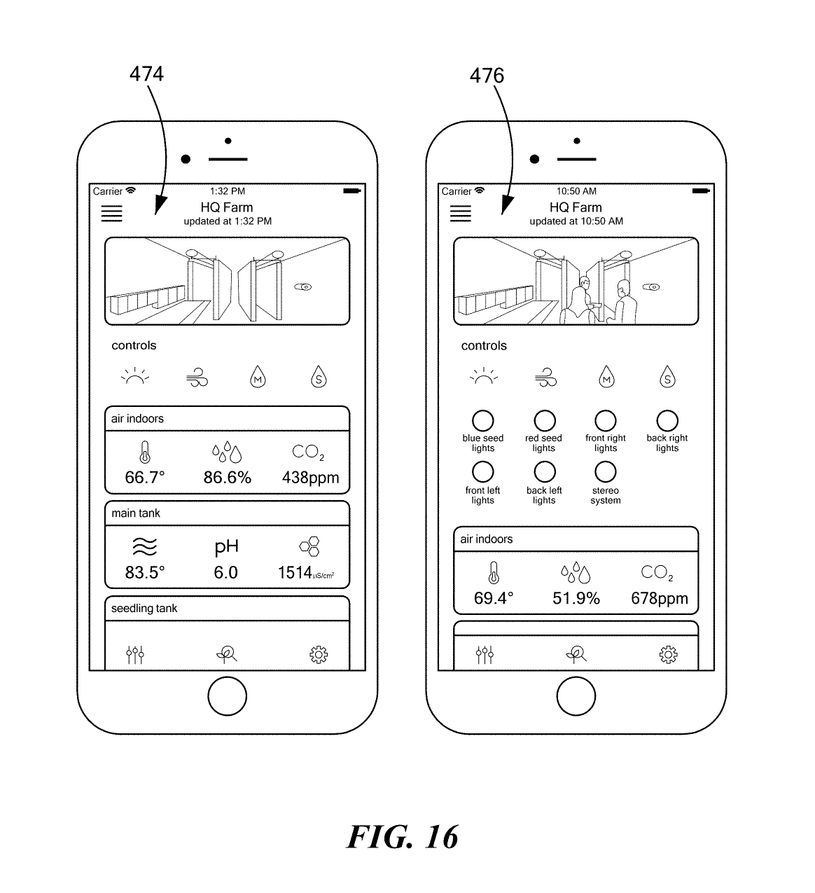

FIGS. 15 and 16 illustrate embodiments of a user interface for real-time monitoring of sensors, outputs, and inputs. For example, FIG. 15 illustrates a screen 430 in which a user can select Controls 432, with aspects to monitor and control, such as lighting 434, ventilation 436, a main growing chamber 438 (indicated by M), or a seedling chamber 442 (indicated by

S). In the embodiment shown, lighting has been selected and various lighting options 444 are presented for selection (Blue Light, Red Light, Front Right, Back Right, Front Left, Back Left, Ghost Valve). A user can select air indoors 446 to monitor or control indoor air parameters such as temperature 448 at one or more locations, humidity 452, and CO₂ level 454. In the embodiment illustrated, an error condition 456 on the humidity level is indicated by the notation “err,” for example, to prompt a user investigation. Historical levels can be viewed and monitored and alerts can be viewed. A user can monitor and control parameters such as temperature 458, pH level 462, and electrolyte conductivity 464 in a main nutrient tank 466 or a seedling nutrient tank 468. A view of a feed from a camera 472 in the farm can be provided. FIG. 16 illustrates similar screens 474, 476 optimized for a mobile device. A user can scroll the screen to bring the various options into view and tap to select the desired option.

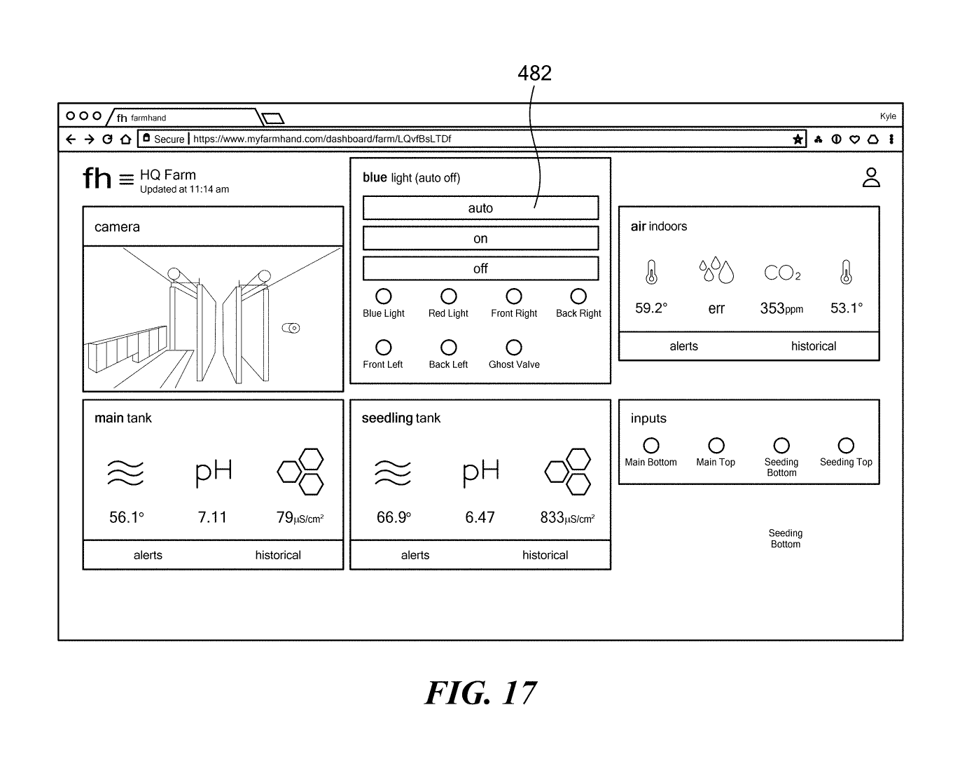

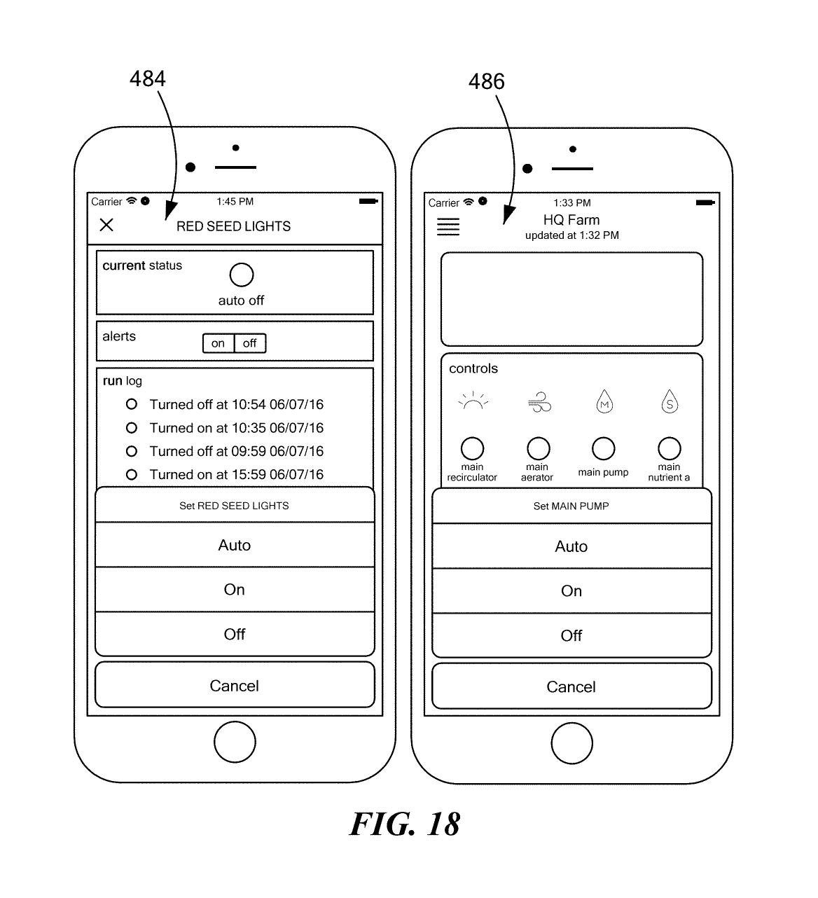

FIGS. 17 and 18 illustrate embodiments of a user interface 480 for controlling farm [symbol] if the “blue light” in FIG. 15 is selected, a screen 482, illustrated in

FIG. 17, appears allowing the user to set the blue light to “on,” “off,” or “auto.” FIG. 18 illustrates analogous screens 484, 486 optimized for a mobile device, indicating control of red seed lights and a main pump.

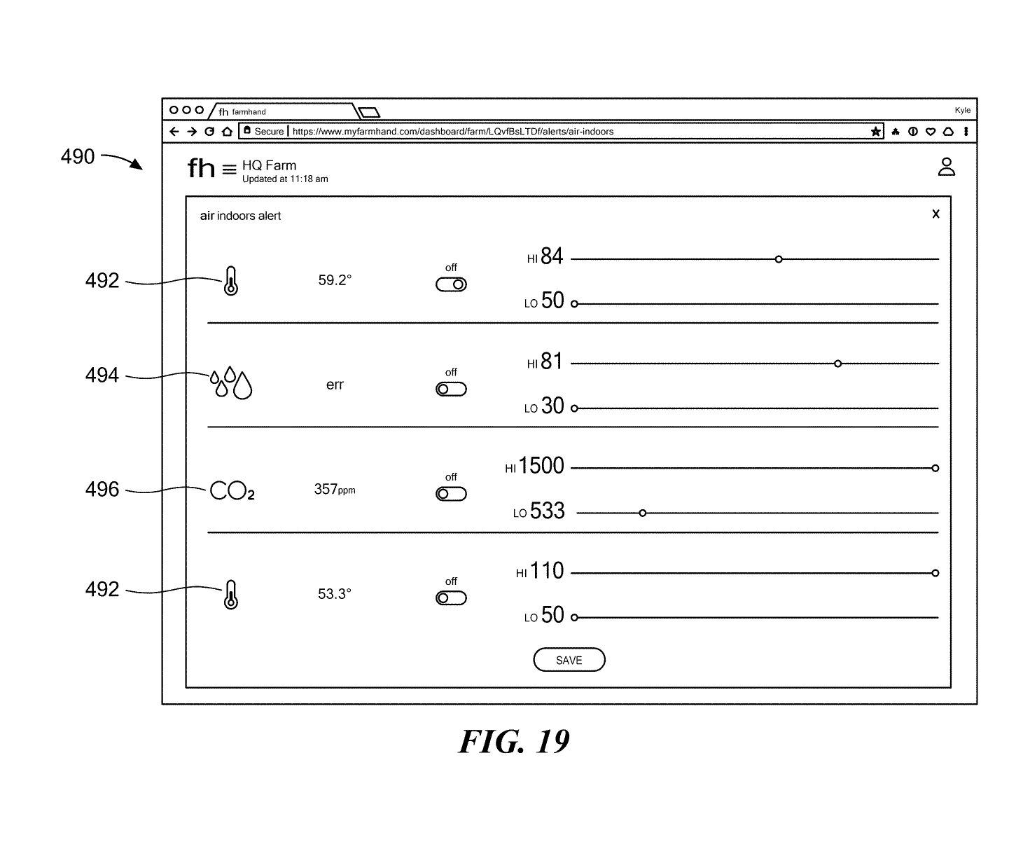

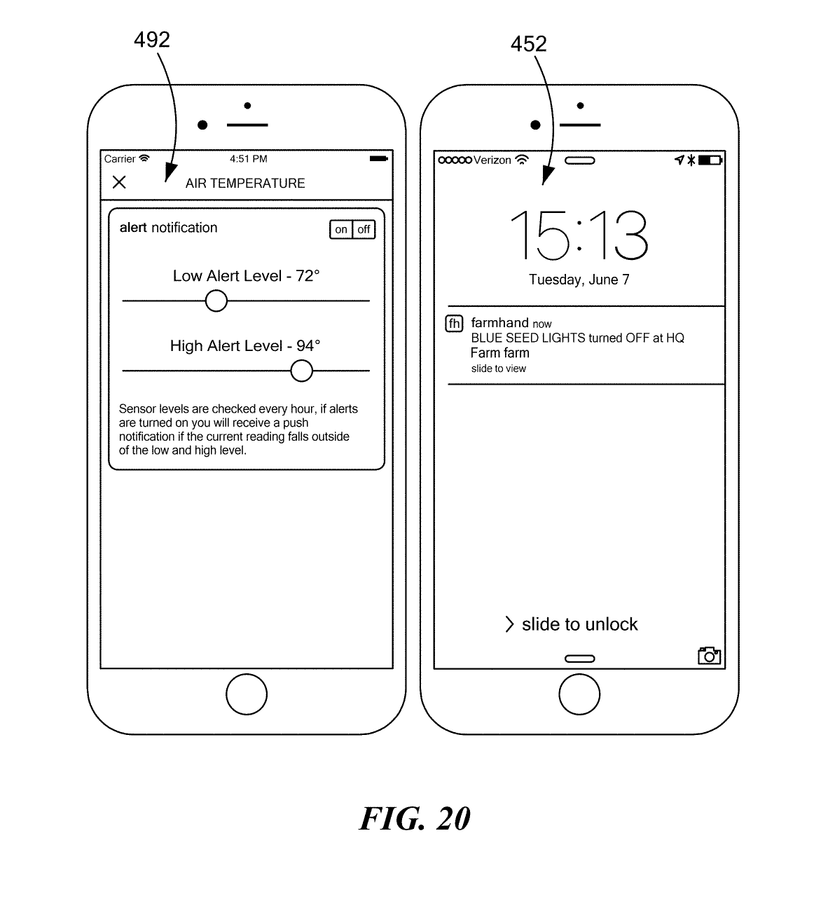

FIGS. 19 and 20 illustrate embodiments of a user interface for receiving alerts for controller events, such as outputs that have turned on or off, sensors that are outside of a set range, and the like. For example, FIG. 19 illustrates a screen 490 showing alerts for air temperature 492, humidity 494, CO₂ level 496. An error condition is present for the humidity level, indicated by the notation “err.” The user can change the settings if desired by changing the indicator bars. FIG. 20 illustrates analogous screens 498, 502 optimized for a mobile device, indicating air temperature low alert level and high alert level, and blue seed light status.

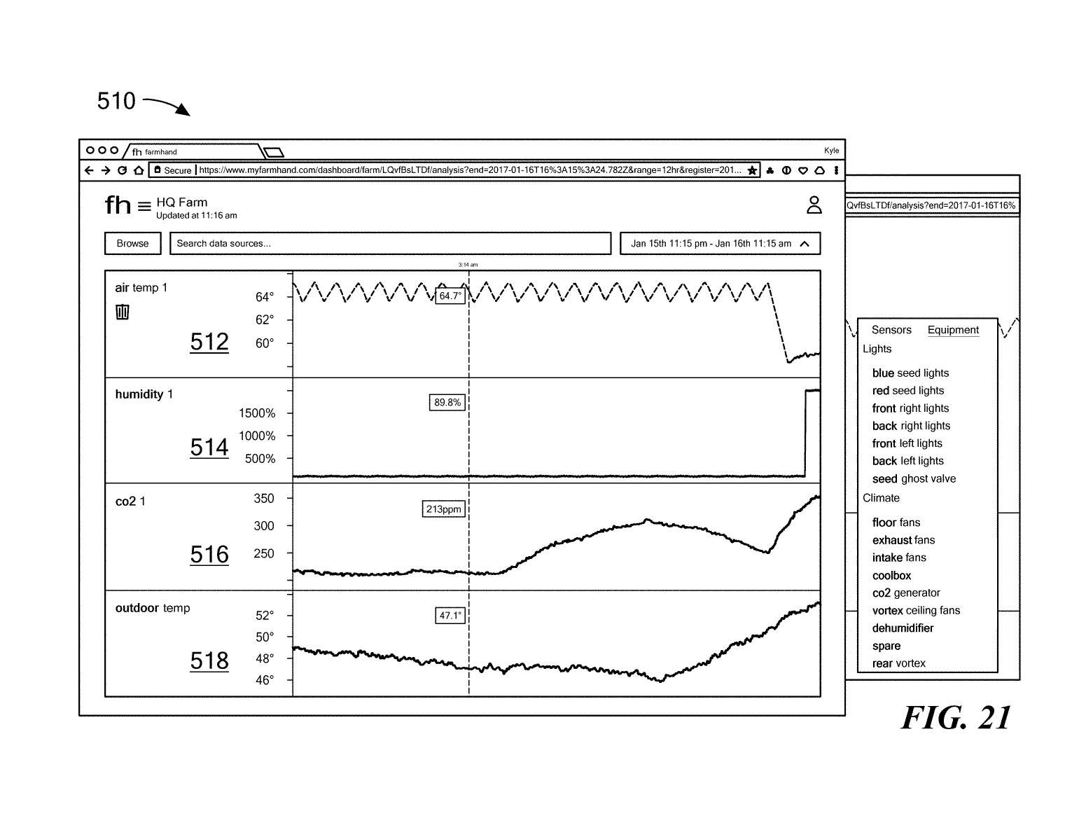

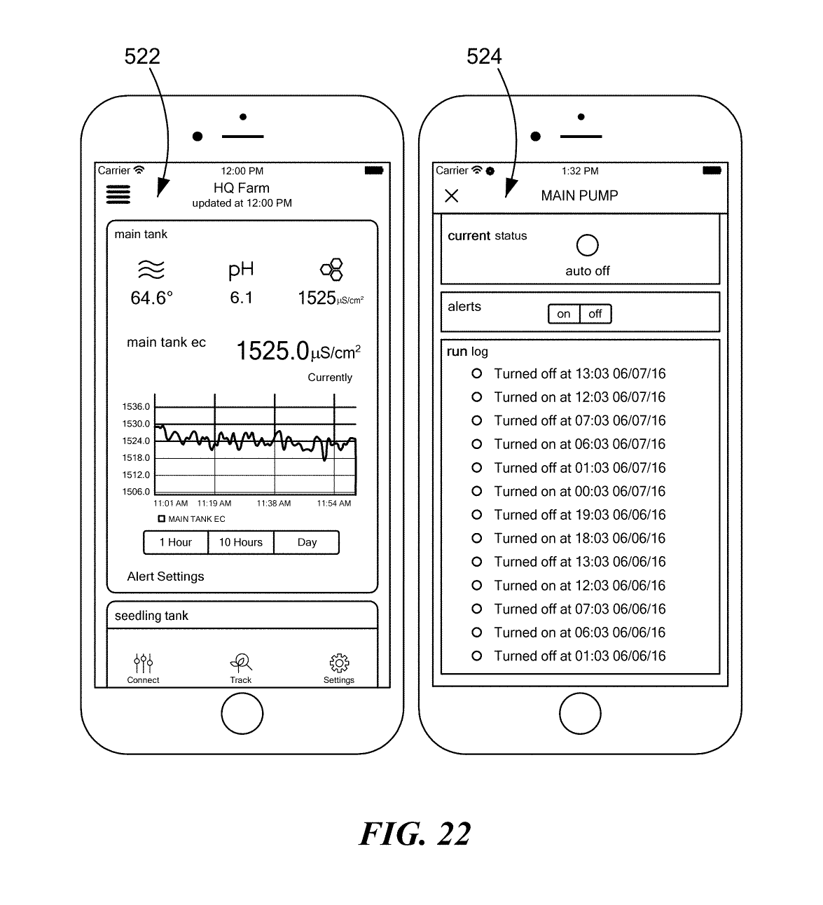

FIGS. 21 and 22 illustrate embodiments of a user interface for viewing historic sensor readings and run logs for various sensors and equipment for any time period. For example. FIG. 21 illustrates a screen 510 with sensor data for air temperature 512, humidity level 514, CO₂ level 516, and outdoor temperature 518. FIG. 22 illustrates analogous screens for a mobile device, showing electrolyte conductivity for a main tank, and current status, alerts setting, and a run log for a main pump.

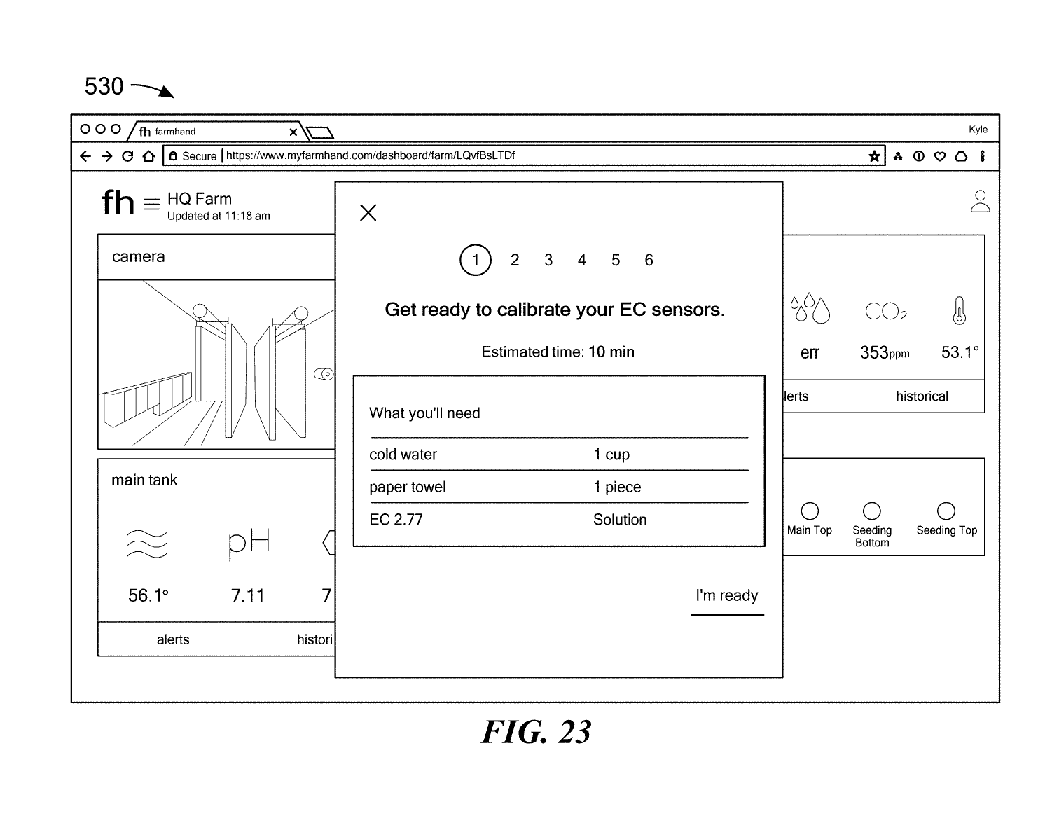

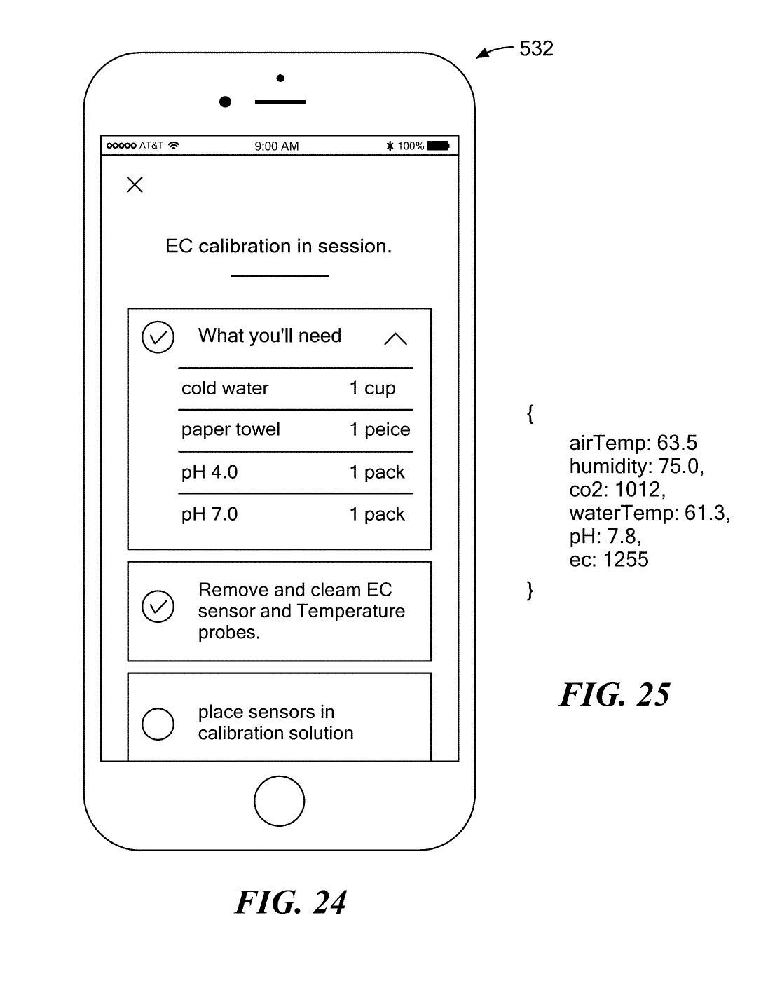

FIGS. 23 and 24 illustrate embodiments of a user interface to guide a user through the steps of performing a calibration or other process. For example, FIG. 23 illustrates a screen 530 showing a first step in a calibration process for an electrolyte conductivity sensor. FIG. 24 illustrates an analogous screen 532 for a mobile device, indicating an electrolyte conductivity calibration in process and showing that a user has completed and checked off the first two steps in the process. Additional screens can be provided to guide users through processes for routine maintenance and cleaning. The system can be implemented as software- and hardware-based tools for controlling and monitoring modular farms as described herein. For example, the farm control system and the farm networking service can be implemented as or can include one or more computing devices that include a combination of hardware, software, and firmware that allows the computing device to run an applications layer or otherwise perform various processing tasks. Computing devices can include without limitation personal computers, work stations, servers, laptop computers, tablet computers, mobile devices, hand-held devices, wireless devices, smartphones, wearable devices, embedded devices, microprocessor-based devices, microcontroller-based devices, programmable consumer electronics, mini-computers, main [symbol] the like.

The computing device can include a basic input/output system (BIOS) and an operating system as software to manage hardware components, coordinate the interface between hardware and software, and manage basic operations such as start up. The computing device can include one or more processors and memory that cooperate with the operating system to provide basic functionality for the computing device. The operating system provides support functionality for the applications layer and other processing tasks. The computing device can include a system bus or other bus (such as memory bus, local bus, peripheral bus, and the like) for providing communication between the various hardware, software, and firmware components and with any external devices. Any type of architecture or infrastructure that allows the components to communicate and interact with each other can be used.

Processing tasks can be carried out by one or more processors. Various types of processing technology can be used, including a single processor or multiple processors, a central processing unit (CPU), multicore processors, parallel processors, or distributed processors. Additional specialized processing resources such as graphics (e.g., a graphics processing unit or GPU), video, multimedia, or mathematical processing capabilities can be provided to perform certain processing tasks. Various learning algorithms can be implemented. Processing tasks can be implemented with computer-executable instructions, such as application programs or other program modules, executed by the computing device. Application programs and program modules can include routines, subroutines, programs, drivers, objects, components, data structures, and the like that perform particular tasks or operate on data.

Processors can include one or more logic devices, such as small-scale integrated circuits, programmable logic arrays, programmable logic device, masked-programmed gate arrays, field programmable gate arrays (FPGAs), and application specific integrated circuits (ASICs). Logic devices can include, without limitation, arithmetic logic blocks and operators, registers, finite state machines, multiplexers, accumulators, comparators, counters, look-up tables, gates, latches, flip-flops, input and output ports, carry in and carry out ports, and parity generators, and interconnection resources for logic blocks, logic units and logic cells. The computing device includes memory or storage, which can be accessed by the system bus or in any other manner. Memory can store control logic, instructions, and/or data. Memory can include transitory memory, such as cache memory, random access memory (RAM), static random access memory (SRAM), main memory, dynamic random access [symbol] memristor memory cells. Memory can include storage for firmware or microcode, such as programmable read only memory (PROM) and erasable programmable read only memory (EPROM). Memory can include non-transitory or nonvolatile or persistent memory such as read only memory (ROM), hard disk drives, optical storage devices, compact disc drives, flash drives, floppy disk drives, magnetic tape drives, memory chips, and memristor memory cells. Non-transitory memory can be provided on a removable storage device. A computer-readable medium can include any physical medium that is capable of encoding instructions and/or storing data that can be subsequently used by a processor to implement embodiments of the method and system described herein. Physical media can include floppy discs, optical discs, CDs, mini-CDs, DVDs, HD-DVDs, Blu-ray discs, hard drives, tape drives, flash memory, or memory chips. Any other type of tangible, non-transitory storage that can provide instructions and/or data to a processor can be used in these embodiments.

The computing device can include one or more input/output interfaces for connecting input and output devices to various other components of the computing device. Input and output devices can include, without limitation, keyboards, mice, joysticks, microphones, displays, touchscreens, monitors, scanners, speakers, and printers. Interfaces can include universal serial bus (USB) ports, serial ports, parallel ports, game ports, and the like.

The computing device can access a network over a network connection that provides the computing device with telecommunications capabilities. Network connection enables the computing device to communicate and interact with any combination of remote devices, remote networks, and remote entities via a communications link. The communications link can be any type of communication link, including without limitation a wired or wireless link. For example, the network connection can allow the computing device to communicate with remote devices over a network, which can be a wired and/or a wireless network, and which can include any combination of intranet, local area networks (LANs), enterprise-wide networks, medium area networks, wide area networks (WANs), the Internet, cellular networks, and the like. Control logic and/or data can be transmitted to and from the computing device via the network connection. The network connection can include a modem, a network interface (such as an Ethernet card), a communication port, a PCMCIA slot and card, or the like to enable transmission of and receipt of data via the communications link.

The computing device can include a browser and a display that allow a user to browse and view pages or other content served by a web server over the communications link. A web server, server, and database can be located at the same or at different locations and can be [symbol] computing device, different computing devices, or distributed across a network. A data center can be located at a remote location and accessed by the computing device over a network.

The computer system can include architecture distributed over one or more networks, such as, for example, a cloud computing architecture. Cloud computing includes without limitation distributed network architectures for providing, for example, software as a service (SaaS), infrastructure as a service (IaaS), platform as a service (PaaS), network as a service (NaaS), data as a service (DaaS), database as a service (DBaaS), desktop as a service (DaaS), backend as a service (BaaS), test environment as a service (TEaaS), API as a service (APIaaS), and integration platform as a service (IPaaS). As used herein, “consisting essentially of” allows the inclusion of materials or steps that do not materially affect the basic and novel characteristics of the claim. Any recitation herein of the term “comprising,” particularly in a description of components of a composition or in a description of elements of a device, can be exchanged with “consisting essentially of” or “consisting of.”

It will be appreciated that the various features of the embodiments described herein can be combined in a variety of ways. For example, a feature described in conjunction with one embodiment may be included in another embodiment even if not explicitly described in conjunction with that embodiment.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the invention.

The present invention has been described in conjunction with certain preferred embodiments. It is to be understood that the invention is not limited to the exact details of construction, operation, exact materials or embodiments shown and described, and that various modifications, substitutions of equivalents, alterations to the compositions, and other changes to the embodiments disclosed herein will be apparent to one of skill in the art.

What is claimed is:

1. A system for controlling a network of farms comprising:
one or more processors and memory, and machine-readable instructions stored in the memory that, upon execution by the one or more processors cause the system to carry out operations comprising:
receiving communications from a plurality of remotely located modular farms, each modular farm comprising a contained environment for growing a crop, the communications including at least data from one or more of a sensor and equipment within the contained environment; and
transmitting a communication to at least one of the modular farms comprising instructions or notifications regarding growing conditions within the contained environment.

2. The system of claim 1, wherein the received communications further include one or more of data relating to crop yield, climate within the contained environment, farm equipment, and farm operations.

3. The system of claim 2, wherein the crop yield data includes an amount of a crop harvested over a time period.

4. The system of claim 2, wherein the climate data includes one or more of humidity, CO₂ level, temperature, light level, air flow across a crop, water levels supplied to a crop, nutrient levels supplied to a crop, and nutrient solution parameters, sensed over time within the contained environment.

5. The system of claim 2, wherein the farm equipment data includes one or more of a duty cycle, nutrient solution reservoir level, nutrient supply reservoir level, fuel tank level, equipment failure notification, and maintenance action notification sensed over time.

6. The system of claim 2, wherein the farm operations data includes amounts of resources consumed over a time period, the resources including one or more of fuel, [symbol] nutrients.

7. The system of claim 1, further comprising one or more modules operative to monitor and control components of each modular farm, the components including one or more of a sensor, equipment, crop recipe, farm organization, user authentication, rule, alert, data verification and settings.

8. The system of claim 1, further comprising aggregating data from multiple modular farms, the aggregated data including data relating to one or more of a crop yield, crop sale pricing, climate data, equipment data, and farm operations data.

9. The system of claim 8, further comprising determining from the aggregated data, one or more of crop recipe optimization for a particular crop, an equipment maintenance prediction, a predicted yield for a particular crop, local or regional crop yields, crop pricing, and crop demand.

10. The system of claim 1, wherein the transmitted communication includes instructions to carry out operations comprising controlling and monitoring one or more of a lighting system, an irrigation system, a climate control system, and a ventilation system within the contained environment.

11. The system of claim 1, wherein the transmitted communication includes a notification to users associated with each of the modular farms, and wherein the notifications are pushed to user devices that are subscribed to receive the notifications.

12. The system of claim 1, wherein the transmitted communication includes instructions for executing farm operation tasks.

13. A method for controlling a network of farms comprising:
receiving, at one or more processors, communications from a plurality of remotely located modular farms, each modular farm comprising a contained environment for growing a crop, the communications including at least data from one or more of a sensor and equipment within the contained environment; and
transmitting, by the one or more processors, a communication to at least one of the modular farms comprising instructions or notifications regarding growing conditions within the contained environment.

14. A system for monitoring and controlling a farm over a network, comprising:
one or more processors and memory, and machine-readable instructions stored in the memory that, upon execution by the one or more processors cause the system to carry out operations comprising:
transmitting communications from at least one modular farm to a remote computing system, the modular farm comprising a contained environment for growing a crop, the communications including at least data from one or more of a sensor and equipment within the contained environment; and
receiving a communication from the remote computing system comprising instructions or notifications regarding growing conditions within the contained environment.

15. The system of claim 14, wherein the transmitted data includes data relating to one or more of a crop yield, climate within the contained environment, farm equipment, and farm operations.

16. The system of claim 14, wherein the transmitted data includes user generated data comprising one or more of pricing data, operational data, location data, purchases, and support data.

17. The system of claim 14, further comprising, at the modular farm, a communication gateway device to enable communication between the modular farm and the remote computing system, and with one or more user devices associated with the modular farm.

18. The system of claim 17, wherein:
the user device is a personal computer, laptop computer, tablet computer, mobile device, smart phone, smart watch, or wearable device; or
the communication gateway device is operative to transmit and receive communications over a wired network or a wireless network.

19. The system of claim 14, wherein the contained environment of the modular farm comprises a container housing racks for growing plants, a lighting system configured to provide light for the plants, an irrigation system configured to provide nutrients to the plants, a climate control system configured to control environmental condition within the container, and a ventilation system configured to provide airflow to the plants.

20. The system of claim 19, further comprising machine-readable instructions stored in the memory that, upon execution by the one or more processors, cause the system to carry out operations comprising controlling and monitoring one or more of the lighting system, the irrigation system, the climate control system, and the ventilation system.

21. A method for monitoring and controlling a farm over a network, comprising:
transmitting, by one or more processors, communications from at least one modular farm to a remote computing system, the modular farm comprising a contained environment for growing a crop, the communications including at least data from one or more of a sensor and equipment within the contained environment; and
receiving, by the one or more processors, a communication from the remote computing system comprising instructions or notifications regarding growing conditions within the contained environment.

22. A system of controlling a farm, comprising:
one or more processors and memory, associated with a farm comprising a contained environment for growing a crop, and machine-readable instructions stored in the memory that, upon execution by the one or more processors cause the system to carry out operations for controlling and monitoring farm operations, and
a user device in communication with the one or more processors,
wherein the operations comprise displaying on the user device a plurality of farm control operations comprising one or more of lighting control, ventilation control, growing chamber parameters, and seedling chamber parameters.

23. The system of claim 22, further comprising displaying on the user device a camera feed from an interior of a modular container.

24. The system of claim 22, further comprising providing one or more of a historical log, a run log, and alert notifications.

25. The system of claim 22, wherein the growing chamber parameters or the seedling chamber parameters include one or more of air temperature, humidity, CO₂ level, nutrient tank temperature, nutrient tank pH level, and nutrient tank electrolyte conductivity.

26. A method of controlling a farm, comprising:
transmitting to a user device associated with a farm a display comprising a plurality of farm control operations comprising one or more of lighting control, ventilation control, growing chamber parameters, and seedling chamber parameters.
